(19) United States
(12) Patent Application Publication
(10) Pub. No.: US 2014/0070578 A1
(43) Pub. Date: Mar. 13, 2014

(54) SEAT ENERGY ABSORPTION DEVICE

(71) Applicant: RECARO Aircraft Seating GmbH & Co. KG., Schwabisch Hall (DE)

(72) Inventors: Michal SZELAGOWSKI, Jelenia Gora (PL); Dieter BRAUN, Otterberg (DE); Heiko MINZER, Schwabisch Hall (DE)

(73) Assignee: RECARO Aircraft Seating GmbH & Co. KG., Schwabisch Hall (DE)

(21) Appl. No.: 14/017,381

(22) Filed: Sep. 4, 2013

(30) Foreign Application Priority Data
Sep. 7, 2012 (DE) 10 2012 108 352.5

(51) Int. Cl. B60N 2/427; B64D 11/06

(52) U.S. Cl. CPC B60N 2/42709; B60N 2/427; B64D 11/06
USPC 297/216.13

(57) ABSTRACT

The invention relates to a seat energy absorption device, in particular an aircraft seat energy absorption device, which is intended, to at least partly absorb at least a primary acceleration movement of at least one backrest unit, at least in a crash situation. The seat energy absorption device has at least one seat energy absorption unit, which is intended to be moved in a crash situation in at least one direction deviating from the primary acceleration movement of the backrest unit.

### PRIOR ART

The invention relates to a seat energy absorption device according to the preamble of Claim 1.

A seat energy absorption device, in particular an aircraft seat energy absorption device, which is intended to at least partly absorb at least one primary acceleration movement of at least one backrest unit, at least in a crash situation, has already been proposed.

The object of the invention in particular is to provide a generic device having improved properties in terms of safety, in particular the safety of a passenger. The object is achieved in accordance with the invention by the features of patent Claim 1, whereas advantageous embodiments and developments of the invention can be inferred from the dependent claims.

### ADVANTAGES OF THE INVENTION

The invention is based on a seat energy absorption device, in particular an aircraft seat energy absorption device, which is intended to at least partly absorb at least one primary acceleration movement of at least one backrest unit, at least in a crash situation.

It is proposed for the seat energy absorption device to have at least one seat energy absorption unit, which is intended, to be moved, in a crash situation, in at least one direction deviating from the primary acceleration movement of the backrest unit. In particular, a “primary acceleration movement” is to be understood to mean an acceleration movement of at least a majority of the backrest unit. In particular, the primary acceleration movement is oriented at least substantially parallel to an acceleration movement of a seat comprising the seat energy absorption unit. The primary acceleration movement is preferably oriented at least substantially parallel to an acceleration movement of a transport means in which at least one seat comprising the seat energy absorption unit is arranged. In particular, a “seat energy absorption unit” is to be understood to mean a unit that is intended, in a crash situation, to at least partly absorb the primary acceleration movement of the backrest unit. In particular, the seat energy absorption unit is intended to be moved, in a crash situation, in the direction deviating from the primary acceleration movement of the backrest unit. In particular, the seat energy absorption unit is intended, to be moved, in a crash situation, in a direction oriented at least substantially against the primary acceleration movement of the backrest unit. The seat energy absorption unit is preferably intended to be moved, in a crash situation, by more than 1 cm, preferably by more than 3 cm, and in particular by more than 5 cm, in the direction deviating from the primary acceleration movement of the backrest unit. In particular, at least a majority of the seat energy absorption unit moves in a crash situation in the direction deviating from the primary acceleration movement of the backrest unit. The majority of the seat energy absorption unit preferably moves in translation in the direction deviating from the primary acceleration movement of the backrest unit. The expression that the seat energy absorption unit is intended, in a crash situation, “to at least partly absorb” the primary acceleration unit of the backrest unit is to be understood in particular to mean that the seat energy absorption unit is intended, in a crash situation, to absorb an energy applied by the primary acceleration movement of the backrest unit and in particular acting on the seat energy absorption unit in a proportion of more than 50%, preferably more than 70%, and in particular more than 90% of an amount of the energy applied by the primary acceleration movement of the backrest unit. In particular, the term “absorb” is to be understood to mean to take up. In particular, the seat energy absorption unit is intended, in a crash situation, to at least partly take up the energy applied by the primary acceleration movement of the backrest unit. The seat energy absorption unit is preferably intended, in a crash situation, to at least partly convert the energy applied by the primary acceleration movement of the backrest unit into at least one further energy different from the first-mentioned energy. In particular, the seat energy absorption unit is intended to at least partly decelerate the primary acceleration movement of the backrest unit, in a crash situation. In particular, a “direction deviating” from the primary acceleration movement of the backrest unit is to be understood to mean a direction that is oriented, by means of a rotation through an angle in a range from 90° to 180° inclusive, in the direction of the primary acceleration movement of the backrest unit. In particular, the direction deviating from the primary acceleration movement of the backrest unit encloses an angle with a primary acceleration movement direction of the primary acceleration movement in a range from 90° to 180° inclusive and/or is oriented against, in particular antiparallel to, the primary acceleration movement direction. A “direction oriented at least substantially against the primary acceleration direction of the backrest unit” is to be understood in particular to mean a direction that deviates from a direction oriented against the primary acceleration direction by less than 10°, preferably by less than 5°, and in particular by less than 3°. A “direction oriented against the primary acceleration direction of the backrest unit” is to be understood in particular to mean a direction that is oriented, by means of a rotation through 180°, in the direction of the primary acceleration direction. A “majority of a unit”, in particular of a backrest unit and/or of a seat energy absorption unit, is to be understood in particular to mean a mass fraction and/or a volume fraction of more than 70%, preferably of more than 75%, and in particular of more than 80%, of an amount of a total mass and/or of a total volume of the unit. Here, a “transport means” is to be understood in particular to mean any type of transport that is equipped with seats and is intended to transport people. For example, a transport means may be a ship, a bus, a motor vehicle, or a rail vehicle, such as a train or a tram. The transport means is preferably an aircraft. The expression that a straight line and/or plane is oriented “at least substantially parallel” to a further straight line and/or plane formed separately from the first-mentioned straight line and/or plane is to be understood in particular to mean that the straight line and/or plane encloses an angle with the further straight line and/or plane that deviates by less than 5°, preferably by less than 3°, and in particular by less than 1°, from an angle of 0°. In particular, “intended” is to be understood to mean specifically designed and/or equipped. Due to an embodiment according to the invention, the primary acceleration movement of the backrest unit can advantageously be absorbed in a structurally simple and reliable manner, whereby safety for a passenger can be advantageously increased.

It is also proposed for the seat energy absorption unit to have at least one attachment point, which is intended for an attachment of the seat energy absorption unit to at least one transverse reinforcement unit. In particular, the seat energy absorption unit has at least one further attachment point, which is intended at least for an attachment of the seat energy absorption unit to the backrest unit. In particular, an “attachment point” is to be understood to mean a point that is intended to connect at least one unit, in particular the seat energy absorption unit, to at least one further unit formed separately from the first-mentioned unit. In particular, the attachment point is intended to couple to one another the unit and the further unit. The attachment point is preferably intended to enable at least one exchange of at least one force and/or at least one energy between the units. In particular, the attachment point is intended to transmit a movement of at least one of the two units to the further of the two units coupled to the first-mentioned unit. In particular, a “transverse reinforcement unit” is to be understood in particular to mean a unit that is intended to reinforce at least one unit, in particular a backrest unit, in a transverse direction of the unit. In particular, the transverse reinforcement unit is intended to couple at least one movement of one side of the unit to a movement of a further side of the unit distanced from the first-mentioned side in the transverse direction of the unit. The transverse reinforcement unit is preferably intended to mount the unit so as to be movable. In particular, the transverse reinforcement unit is mounted, in particular movably, on at least one stand unit of at least one seat, in particular on at least one seat divider of the seat. The transverse reinforcement unit preferably has a transverse reinforcement unit transverse direction, which is oriented at least substantially parallel to a stand surface of the seat, in particular to the base. In particular, the transverse reinforcement unit transverse direction is oriented at least substantially perpendicular to a seat direction. In particular, the unit transverse direction is oriented at least substantially parallel to the transverse reinforcement unit transverse direction. The unit is preferably formed as a backrest unit. In particular, the transverse reinforcement unit is coupled by means of the seat energy absorption unit to the backrest unit. It is additionally conceivable for the unit to be formed as a seat base unit, wherein the transverse reinforcement unit is coupled preferably directly to the seat base unit. It is thus conceivable for the backrest unit and the seat base unit, in particular a movement of the backrest unit and the seat base unit, to be coupled to one another by means of the transverse reinforcement unit. Alternatively, it is conceivable for the transverse reinforcement unit to be mounted, preferably fixedly, in particular in a manner fixed against rotation, on the stand unit of the seat, in particular on at least one seat divider of the seat. It is also conceivable for the transverse reinforcement unit to be mounted on a supporting tube of the stand unit of the seat. It is likewise conceivable for the transverse reinforcement unit to be mounted on a further component of the stand unit of the seat appearing sensible to a person skilled in the art. The expression that a straight line and/or plane is oriented “at least substantially perpendicular” to a further straight line and/or plane formed separately from the first-mentioned straight line and/or plane is to be understood in particular to mean that the straight line and/or plane encloses an angle with the further straight line and/or plane deviating by less than 5°, preferably by less than 3°, and in particular by less than 1°, from an angle of 90°. In particular, a “stand unit” is to be understood to mean a unit that is intended to stand a seat, in particular a seat having a seat base unit and having a backrest unit, on a floor, in particular on a floor of a transport means. In particular, the stand unit is intended to transmit to the floor weight forces of the seat and, should a person sit on the seat, weight forces of the person sitting on the seat and/or acceleration forces caused by a transport and acting on the person. In particular, a “seat divider” is to be understood to mean a component of a row of seats comprising at least two seats arranged side by side, said component being arranged at least substantially above at least one crossmember, in particular a single beam and/or a cross bar, with respect to a vertical direction oriented vertically to a stand area of the row of seats. In particular, the seat divider is a rigidly formed component of the row of seats. With respect to the vertical direction, the seat divider is preferably arranged at least substantially above a seat base unit of a respective seat of the at least two seats, arranged side by side, in the row of seats. In particular, the seat divider is intended to support an armrest unit. The seat divider is preferably intended to enable a belt attachment. In particular, the seat divider is intended to support a supporting tube. The seat divider preferably forms a lateral boundary of at least one of the at least two seats arranged side by side, wherein the seat divider can be arranged on the aisle side and/or on the vehicle body side, and/or forms a border between two seats, arranged side by side, of the at least two seats. In particular, the seat divider is a component of a force dissipation system, which dissipates force via the backrest unit, the seat divider, a supporting tube structure, and the stand unit into a stand area, in particular into the floor. In particular, a “seat direction” is to be understood to mean a direction that, when a passenger is seated correctly, in particular when a passenger's thighs are oriented parallel, corresponds substantially to the direction in which the passenger's thighs extend from the seat to the knee region. In an upright position of the seat, in which the backrest unit is oriented at least substantially perpendicular to the floor, the seat direction is oriented parallel to the floor and at least substantially perpendicular to the backrest area formed by the backrest unit. If the seat device is used for an air passenger seat, the seat direction typically corresponds to the direction of flight. Due to an embodiment according to the invention, the seat energy absorption unit can advantageously be connected to the transverse reinforcement unit, whereby a secure mounting of the seat energy absorption unit can be achieved. A reliable and safe seat energy absorption unit can thus advantageously be produced.

In addition, it is proposed for the transverse reinforcement unit to be formed as a torsion element. In particular, a “torsion element” is to be understood to mean an element that is intended to absorb, in particular to take up, at least one torsional force. In particular, the torsion element is intended to divert at least one force acting on the torsion element and/or at least one energy acting on the torsion element, in particular into a stand unit. For example, the torsion element, when considered in a cross-sectional plane, has an angular, for example a triangular and/or square and/or polygonal, form. It is likewise conceivable for the torsion element, when considered in the cross-sectional plane, to have an oval, for example an elliptical, form. In particular, the torsion element, when considered in the cross-sectional plane, has a round form. The torsion element is preferably formed as a torsion tube. Due to an embodiment according to the invention, the transverse reinforcement unit may advantageously perform, in addition to an actual function of the transverse reinforcement unit, a function of a torsion element. A separately formed torsion element can thus advantageously be saved, and costs and weight can therefore be reduced. In addition, torsional forces can advantageously be absorbed by the torsion element, and the safety of a passenger can thereby be further increased.

Furthermore, it is proposed for the seat energy absorption unit to have at least one delay element which delimits at least one delay slit and which is intended to decelerate a movement of at least one element, in the crash situation. In particular, a “delay element” is to be understood to mean an element that is intended to decelerate the movement of the element, in the crash situation. In particular, the element is formed as the backrest unit. The element is preferably formed as the seat energy absorption unit. In particular, the delay element is intended to decelerate, in particular to absorb, the primary acceleration movement of the backrest unit. In particular, a “delay slit” is to be understood to mean a slit that has a slit longitudinal extension with an amount that is more than 3 times, preferably more than 5 times, and in particular more than 10 times, greater than an amount of a maximum slit transverse extension. In particular, a “slit longitudinal extension” is to be understood to mean a maximum extension between two surface points of a slit delimitation surface of the delay element delimiting the delay slit, in particular when considered in at least one plane, in which the delay element at least substantially encloses the delay slit. In particular, the slit longitudinal extension is oriented at least substantially perpendicular to the transverse reinforcement unit transverse direction. The slit longitudinal extension is preferably oriented at least substantially parallel to the seat direction. In particular a “slit transverse extension” is to be understood to mean a maximum extension, oriented at least substantially perpendicular to the slit longitudinal extension, between two surface points of the slit delimitation surface of the delay element delimiting the delay slit. In particular, the slit transverse extension is oriented at least substantially perpendicular to the transverse reinforcement unit transverse direction. The slit transverse extension is preferably oriented at least substantially perpendicular to the seat direction. A plane in which the delay element “at least substantially encloses” the delay slit is to be understood in particular to mean that the delay element surrounds the delay slit in the plane over an angular range of more than 300°, preferably more than 330°, and in particular more than 350°. Due to an embodiment according to the invention, the movement of the element can advantageously be decelerated safely and in a constructionally simple manner.

It is further proposed for the delay slit to have at least two different slit transverse extensions. In particular, the delay slit has at least three different slit transverse extensions. The delay slit preferably has a tapering course extending in a slit longitudinal direction oriented at least substantially perpendicular to the slit transverse extension. In particular, the tapering course extends in the direction of the slit longitudinal extension starting from a surface point facing toward the backrest unit and delimiting the slit longitudinal extension, wherein the tapering course transitions at least at substantially 50% of an amount of the slit longitudinal extension into a widening course. In this context, the expression “at least substantially” is to be understood in particular to mean that a deviation from a predefined value deviates in particular less than 25%, preferably less than 10%, and particularly preferably less than 5%, from the predefined value. In particular, a “slit longitudinal direction” is to be understood to mean a direction that is oriented, in an assembled state of the seat energy absorption unit and starting from a region facing toward the backrest unit, in the direction of a region of the seat energy absorption unit remote from the backrest unit and at least substantially parallel to the slit longitudinal direction. Due to an embodiment according to the invention, a defined introduction of force into the delay element can advantageously be implemented safely.

In addition, it is proposed for the seat energy absorption unit to be intended to absorb energy at least by plastic deformation, in the crash situation. In particular, a “plastic deformation” of a unit, in particular of the seat energy absorption unit, is to be understood to mean an irreversible change to the form of the unit under the action of an external force and/or energy on the unit. In particular, the plastic deformation is to be understood to mean a property of the unit to irreversibly deform under the action of an external force and/or energy on the unit and to retain a form obtained as a result of the deformation once the action of the external force and/or energy has ended. Due to an embodiment according to the invention, an effective, safe conversion of the primary acceleration movement into deformation energy can advantageously be achieved.

Furthermore, it is proposed for the seat energy absorption unit to have an at least substantially U-shaped form in at least one cross-sectional plane. In particular, an “at least substantially U-shaped form” of a unit is to be understood to mean a form that is open in one direction, wherein holes and/or recesses and/or slits introduced into the unit are to be understood as belonging to the unit. In particular, the seat energy absorption unit has a U-shaped form in the cross-sectional plane. Alternatively, it is conceivable for the seat energy absorption unit to have a V-shaped form in the cross-sectional plane. It is likewise conceivable for the seat energy absorption unit to have an arc-shaped, for example oval and/or circular, form in the cross-sectional plane. For example, it is conceivable for the seat energy absorption unit to have a step-shaped form in the cross-sectional plane. Due to an embodiment according to the invention, a force and/or energy acting on the seat energy absorption unit can advantageously be absorbed, in particular taken up, favorably and safely.

Furthermore, it is proposed for the seat energy absorption unit to have an at least substantially arc-like form in the longitudinal direction. In particular, an “at least substantially arc-like form” of the seat energy absorption unit is to be understood to mean a form that, with a virtual connection formed as a straight line between two ends of the seat energy absorption unit that are spaced with respect with the longitudinal direction, is arranged on one side of the straight line and is distanced from the straight line. In particular, a distance of the form from the straight line is maximal at least at substantially 50% of an amount of an extension of the straight line between the two ends. The two ends are preferably arranged in an end region, preferably in an assembled state in a lower end region, of the seat energy absorption unit with respect to a vertical direction oriented at least substantially perpendicular to the longitudinal direction and also to a transverse direction of the seat energy absorption unit. In particular, the seat energy absorption unit has an arc-shaped form in the longitudinal direction. Alternatively, it is conceivable for the seat energy absorption unit to have an at least substantially U-shaped form in the longitudinal direction. Due to an embodiment according to the invention, the seat energy absorption unit may advantageously be arranged at a distance from the transverse reinforcement unit in the event of a movement of the backrest unit, whereby a collision between the seat energy absorption unit and the transverse reinforcement unit can advantageously be avoided and a functionality of the seat energy absorption unit can be maintained. The safety for a passenger can thus advantageously be further increased.

In addition, a seat, in particular an aircraft seat, comprising at least one seat energy absorption device according to the invention is proposed. For example, it is conceivable for the seat to have a single seat energy absorption device, which, in an assembled state, is arranged in a side region of the seat, in particular at a lower backrest frame end of the backrest unit, and connects the backrest unit in the side region to the transverse reinforcement unit. It is likewise conceivable for the seat energy absorption device of the seat to be arranged in a middle of the seat and to connect the backrest unit centrally to the transverse reinforcement unit. In particular, the seat has at least two seat energy absorption devices, which, in an assembled state, are each arranged in a side region of the seat and in each case connect the backrest unit to the transverse reinforcement unit. Due to an embodiment according to the invention, a safer seat can advantageously be achieved.

Furthermore, it is proposed for the seat to have at least one backrest unit, which is intended to be linked to the seat energy absorption device in a lower region of the backrest unit. In particular, a “lower region” of the backrest unit is to be understood to mean a region that, in an assembled state of the seat is arranged in an end region of the backrest unit facing toward a stand area, in particular a floor. In particular, the lower region has a region extension which is oriented at least substantially parallel to a backrest unit longitudinal extension and which has an amount of less than 30%, preferably of less than 15%, and in particular of less than 10%, of an amount of the backrest unit longitudinal extension. The lower region preferably has a region surface with an amount of less than 30%, preferably of less than 15%, and in particular of less than 10%, of an amount of a backrest unit surface. Due to an embodiment according to the invention, a large lever effect can advantageously be produced. In addition, the seat energy absorption unit, in an assembled state, may advantageously be arranged beneath a seat base unit, whereby a collision of the seat energy absorption unit with a passenger sitting on a seat base unit of the seat can advantageously be avoided. A safe mounting of the seat energy absorption unit can thus advantageously be achieved.

The seat energy absorption unit according to the invention is not to be limited here to the above-described use and embodiment. In particular, the seat energy absorption device according to the invention may have a number of individual elements, components and units deviating from a number mentioned herein in order to fulfill a functionality described herein.

### DRAWINGS

Further advantages will emerge from the following description of the drawings. An exemplary embodiment of the invention is illustrated in the drawings. The drawings, the description, and the claims contain numerous features in combination. A person skilled in the art will also expediently consider the features individually and combine them to form meaningful further combinations.

In the drawings:

FIG. 1 shows a simplified, perspective illustration of a detail of a seat according to the invention with a seat energy absorption device according to the invention, and

FIG. 2 shows a perspective illustration of the seat energy absorption device according to the invention from FIG. 1.

### DESCRIPTION OF THE EXEMPLARY EMBODIMENT

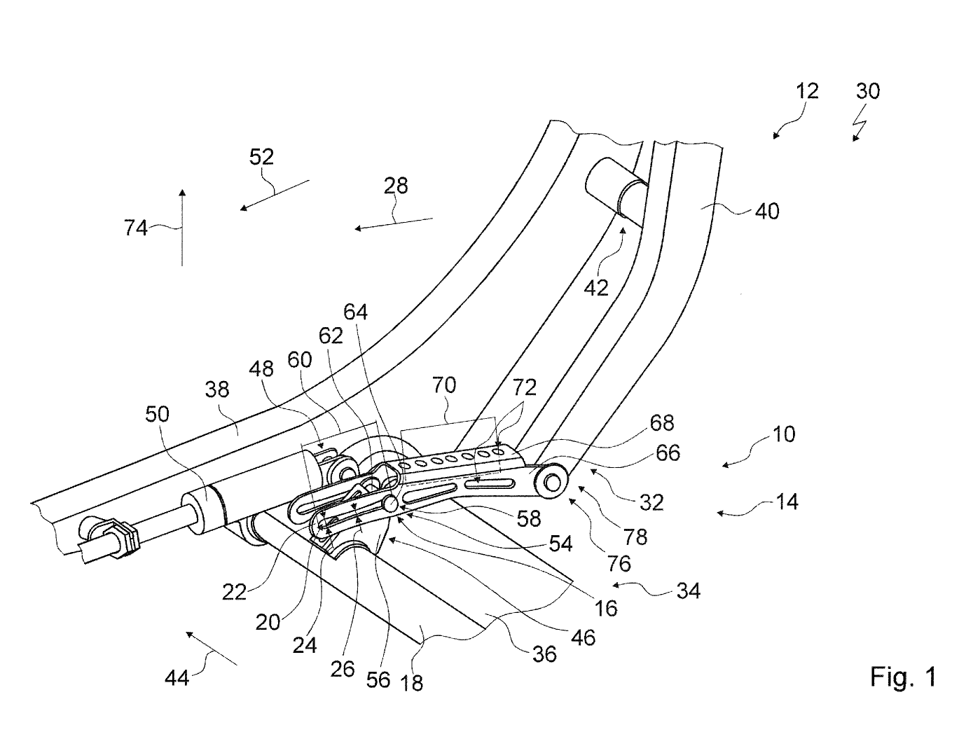

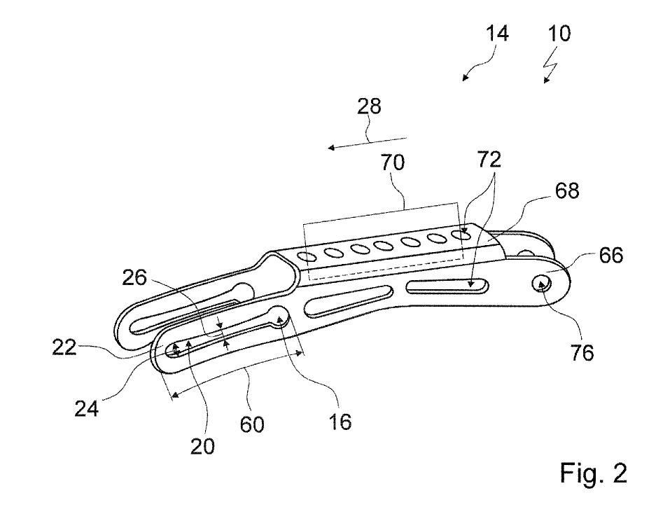

FIG. 1 shows a simplified, perspective illustration of a detail of a seat 30 according to the invention comprising a seat energy absorption device 10 according to the invention. In FIG. 1, merely the features essential to the invention are illustrated. FIG. 1 shows merely one side of the seat 30. The seat 30 comprises two seat energy absorption devices 10 according to the invention, wherein the seat energy absorption device 10 shown in FIG. 1 is arranged on one side of the seat 30, and the further seat energy absorption device 10 is arranged on a further side of the seat 30 distanced from the shown side in a transverse reinforcement unit transverse direction 44. Hereinafter, merely the side of the seat 30 shown in FIG. 1 will be described, wherein it is clear for a person skilled in the art that the further side of the seat 30 distanced from the shown side in the transverse reinforcement unit transverse direction 44 is formed in a substantially identical manner. Alternatively, it will be noted expressly in the following description that corresponding features concern merely the shown side. In addition, for the sake of clarity, some reference signs based on the seat energy absorption device 10 are illustrated merely in FIG. 2. FIG. 2 shows a perspective illustration of the seat energy absorption device 10 according to the invention from FIG. 1.

The seat 30 is formed as an aircraft seat. Similarly, the seat energy absorption device 10 is formed as an aircraft seat energy absorption device. The seat 30 has a stand unit 34, which is intended to stand the seat 30 on a floor of an aircraft (not illustrated). The stand unit 34 is illustrated merely in part in FIG. 1. For example, a supporting tube 36 of the stand unit 34 is illustrated in part in FIG. 1. The seat 30 has a seat divider 38, which is formed as a lateral boundary of the seat 30. In addition, the seat divider 38 is intended to support the supporting tube 36. The seat 30 has a seat base unit (not illustrated), which forms a seat area for a passenger (not illustrated). In addition, the seat 30 has an armrest unit (not illustrated) for resting a passenger's arm. The seat divider 38 is intended to support the armrest unit and also the seat base unit.

The seat 30 is equipped with a backrest unit 12, which is intended to be linked in a lower region 32 of the backrest unit 12 to the seat energy absorption device 10. The backrest unit 12 is likewise only illustrated in part in FIG. 1. The backrest unit 12 has a backrest frame 40, which is linked in the lower region 32 to the seat energy absorption device 10. The backrest unit 12 is mounted pivotably on the seat 30. The seat divider 38 has a backrest bearing point 42, by means of which the backrest unit 12 is mounted pivotably on the seat divider 38. More specifically, the backrest unit 12 is mounted pivotably on the seat divider 38 by means of the backrest frame 40. The seat 30 has what is known as a hydrolock 50, which is intended to move the backrest unit 12. In the present exemplary embodiment, the seat 30 has merely one hydrolock 50, which is arranged on the side of the seat 30 shown in FIG. 1. It is likewise conceivable for the seat 30 to have two hydrolocks 50, wherein the hydrolock 50 is arranged on the side of the seat 30 shown in FIG. 1 and the further hydrolock 50 is arranged on the further side of the seat 30 distanced in the transverse reinforcement unit transverse direction 44.

The seat 30 is equipped with a transverse reinforcement unit 18, which is intended to reinforce the backrest unit 12 in the transverse reinforcement unit transverse direction 44. In addition, the transverse reinforcement unit 18 is intended to connect one side of the seat 30 to the further side of the seat 30. The transverse reinforcement unit 18 is mounted rotatably in the seat divider 38. The transverse reinforcement unit 18 is intended to be rotated with the movement of the backrest unit 12. The transverse reinforcement unit 18 is formed as a torsion element. In the present exemplary embodiment, the torsion element is formed as a torsion tube. The backrest unit 12 and the transverse reinforcement unit 18 are coupled to one another by means of the seat energy absorption device 10. The transverse reinforcement unit 18 has a bearing unit 46, which is intended to provide a coupling to the seat energy absorption device 10. In the present exemplary embodiment, the bearing unit 46 is welded to the transverse reinforcement unit 18. It is likewise conceivable for the bearing unit 46 to be adhesively bonded to the transverse reinforcement unit 18. It is additionally conceivable for the bearing unit 46 and the transverse reinforcement unit 18 to be formed in one piece. The bearing unit 46 has two bearing elements 56. The bearing unit 46 comprises two bearing unit receptacles 58, which are intended to receive an entrainment unit 54 in an assembled state. Of the two bearing elements 56 and also the two bearing unit receptacles 58, only one is described hereinafter and provided with reference signs in FIG. 1 and FIG. 2. The bearing unit receptacle 58 is arranged on the bearing element 56. The bearing unit receptacle 58 has a substantially round cross-sectional shape.

The transverse reinforcement unit 18 has a further bearing unit 48, which is intended for attachment of the hydrolock 50. The seat 30 has merely one further bearing unit 48, which, similarly to the hydrolock 50, is likewise arranged merely on the side of the seat 30 shown in FIG. 1. The further bearing unit 48 is welded to the transverse reinforcement unit 18, similarly to the bearing unit 46. In addition, the further bearing unit 48 is formed substantially identically to the bearing unit 46, as a result of which a detailed description of the further bearing unit 48 is omitted. The hydrolock 50 is connected to the seat divider 38 at an end of the hydrolock 50 pointing away from the transverse reinforcement unit 18.

The seat 30 comprises the seat energy absorption device 10, more specifically the aircraft seat energy absorption device, which is intended, in a crash situation, to partly absorb a primary acceleration movement of the backrest unit 12. The seat energy absorption device 10 comprises a seat energy absorption unit 14, which is intended to be moved, in a crash situation, in at least one direction deviating from the primary acceleration movement of the backrest unit 12. In a crash situation, the primary acceleration movement of the backrest unit 12 is oriented substantially parallel to a seat direction 52. The direction deviating from the primary acceleration movement of the backrest unit 12 is oriented substantially against the seat direction 52. A movement of components of the seat 30 will be explained in greater detail further below. The seat energy absorption device 10 will be described first however. To this end, reference is made in particular to FIG. 2 as well as FIG. 1.

The seat energy absorption unit 14 has a substantially U-shaped form in a cross-sectional plane. The seat energy absorption unit 14 has two side elements 66, which are oriented substantially parallel to a longitudinal direction 28 of the seat energy absorption unit 14. In addition, the seat energy absorption unit 14 has a connecting element 68, which is intended to interconnect the side elements 66. The seat energy absorption unit 14 is formed axially symmetrically about a plane of symmetry 70. The plane of symmetry 70 is oriented substantially parallel to the longitudinal direction 28 and also substantially perpendicular to the transverse reinforcement unit transverse direction 44. Due to the symmetrical formation of the seat energy absorption unit 14 about the plane of symmetry 70, merely one of the side elements 66 will be described hereinafter. The seat energy absorption unit 14 comprises a plurality of shaped recesses 72 in order to reduce a weight of the seat energy absorption unit 14. It is also conceivable for seat energy absorption unit 14 to have a different number of shaped recesses 72, in particular even an embodiment of the seat energy absorption unit 14 with avoidance of shaped recesses 72. Two of the shaped recesses 72 are arranged on the side element 66. The shaped recesses 72 arranged on the side element 66 are formed as shaped recess slits. A multiplicity of shaped recesses 72 is arranged on the connecting element 68. The shaped recesses 72 arranged on the connecting element 68 are formed as shaped recess circles. For the sake of clarity, merely one of the shaped recesses 72 is provided with reference signs in each of FIGS. 1 and 2.

The seat energy absorption unit 14 has a substantially arc-like form in the longitudinal direction 28. When the side element 66 is considered in isolation, the side element 66 has the form of a boomerang. The seat energy absorption unit 14 thus always runs above the transverse reinforcement unit 18 with a movement of the backrest unit 12 and therefore of the seat energy absorption unit 14. The seat energy absorption unit 14 has two delay elements 22, which each delimit a delay slit 20 and are intended to decelerate a movement of an element, in the crash situation. The two delay elements 22 are formed substantially identically, as a result of which merely one of the two delay elements 22 is described hereinafter and provided with reference signs in FIG. 1 and FIG. 2. Further features of the delay element 22 that will be described hereinafter can be applied to both delay elements 22 due to the substantially identical formation. The element comprises the backrest unit 12. In addition, the element comprises the seat energy absorption unit 14. The delay element 22 is intended to decelerate the primary acceleration movement of the backrest unit 12. More specifically, the delay element 22 is intended to decelerate the primary acceleration movement of the backrest unit 12 by means of the seat energy absorption unit 14. The delay element 22 is arranged on the side element 66 of the seat energy absorption unit 14. More specifically, the delay element 22, considered in the longitudinal direction 28, is arranged in an end region of the side element 66.

The seat energy absorption unit 14 has an attachment point 16, which is intended for attachment of the seat energy absorption unit 14 to the transverse reinforcement unit 18. The attachment point 16 is surrounded by the delay element 22 and is formed as a recess in the delay element 22. The attachment point 16 has a substantially round cross-sectional shape. The seat 30 has an entrainment unit 54, which is intended, in a crash situation, to cooperate with the seat energy absorption unit 14. The entrainment unit 54 is intended to couple the seat energy absorption unit 14 to the transverse reinforcement unit 18. The entrainment unit 54 is formed as an entrainment pin. A cross-sectional shape of the entrainment unit 54 is adapted to a cross-sectional shape of the attachment point 16. The entrainment unit 54 has an entrainment element 62, which is intended, in an assembled state, to engage through the attachment point 16 of the seat energy absorption unit 14 and also through the bearing unit receptacle 58 of the bearing unit 46. In the assembled state, the entrainment element 62 is mounted in a form-locked manner in the attachment point 16. The entrainment element 62 has a diameter that is adapted to a diameter of the attachment point 16. The diameter of the entrainment element 62 is slightly smaller than the diameter of the attachment point 16. The entrainment element 62 is mounted in the assembled state in a form-locked manner in the attachment point 16. The entrainment unit 54 has, at its respective ends, an entrainment head 64, which is intended to secure the entrainment unit 54 in the attachment point 16 in the assembled state. The respective entrainment head 64 has a round cross-sectional shape, wherein a diameter of the respective entrainment head 64 is greater than a diameter of the attachment point 16. The entrainment unit 54 is intended, in the crash situation, to cooperate with the delay element 22.

As already mentioned, the backrest unit 12 is linked to the seat energy absorption device 10. The seat energy absorption unit 14 has a further attachment point 76, which is intended for attachment of the seat energy absorption unit 14 to the backrest unit 12. The further attachment point 76 is formed substantially identically to the attachment point 16, as a result of which a detailed description is omitted hereinafter. The seat 30 has a further entrainment unit 78, which is intended, in a crash situation, to cooperate with the seat energy absorption unit 14. The further entrainment unit 78 is intended to couple the seat energy absorption unit 14 to the backrest unit 12. The further entrainment unit 78 is formed similarly to the entrainment unit 54, as a result of which a detailed description hereinafter is omitted.

The delay slit 20 is oriented in a slit longitudinal direction starting from the attachment point 16. The slit longitudinal direction encloses a minimum angle with the longitudinal direction 28 of the seat energy absorption unit 14 of approximately 10°. Starting from the attachment point 16, the delay slit 20 in the longitudinal direction 28 has a tapering course. At approximately 50% of an amount of a slit longitudinal extension 60, the tapering course transitions into a widening course. The slit longitudinal extension 60 is oriented substantially parallel to the slit longitudinal direction. The delay slit 20 has a plurality of different slit transverse extensions 24, 26. The slit transverse extensions 24, 26 have an amount that is smaller than an amount of the diameter of the entrainment element 62 of the entrainment unit 54.

In a crash situation, the aircraft and therefore the seat 30 stood in the aircraft will be accelerated in the direction of the seat direction 52. Here, in a crash situation, a majority of the backrest unit 12 will be accelerated in the direction of the seat direction 52 due to an inertia. More specifically, the majority of the backrest unit 12 will be accelerated in the direction of the seat direction 52, this majority being arranged above the backrest bearing point 42 with respect to a vertical direction 74 oriented substantially perpendicular to the floor. As already mentioned, the primary acceleration movement of the backrest unit 12 is oriented parallel to the seat direction 52. In a crash situation, the majority of the backrest unit 12 moves in the direction of the seat direction 52. Due to the inertia and also due to the pivotable mounting of the backrest unit 12, the lower region 32 of the backrest unit 12 moves against the seat direction 52. Due to the attachment of the backrest unit 12 to the seat energy absorption unit 14, the lower region 32 of the backrest unit 12 entrains the seat energy absorption unit 14 against the seat direction 52 in the event of movement. The seat energy absorption unit 14 thus moves against the seat direction 52 in a crash situation.

As already mentioned, the seat energy absorption unit 14 is attached to the transverse reinforcement unit 18 by means of the attachment point 16. The transverse reinforcement unit 18 is mounted rotatably on the seat divider 38, which is fixedly connected to the floor of the aircraft via the stand unit 34. In a crash situation, the seat energy absorption unit 14 exerts a force oriented against the seat direction 52 onto the transverse reinforcement unit 18. Depending on a position of the transverse reinforcement unit 18 in a crash situation, the transverse reinforcement unit 18 rotates until the bearing unit 46 points against the seat direction 52. A further movement of the transverse reinforcement unit 18 against the seat direction 52 is blocked due to the mounting of the transverse reinforcement unit 18 in the seat divider 38.

The seat energy absorption unit 14 is intended to absorb energy by plastic deformation, in a crash situation. At the latest in the above-described position of the transverse reinforcement unit 18, in which the bearing unit 46 is directed against the seat direction 52, the seat energy absorption unit 14 enables a further movement of the lower region 32 of the backrest unit 12 against the seat direction 52 due to the plastic deformation. The seat energy absorption unit 14 is intended to decelerate the further movement of the lower region 32 of the backrest unit 12 against the seat direction 52. Due to the force against the seat direction 52, the delay slit 20 moves via its tapering course over the entrainment unit 54. The delay element 22, delimiting the delay slit 20, and the entrainment unit 54 cooperate in a crash situation. The seat energy absorption unit 14 is intended, in a crash situation, to absorb the primary acceleration movement of the backrest unit 12 by plastic deformation. In a crash situation, the backrest unit 12 will be accelerated beyond a retaining force of the attachment point 16 and of the entrainment unit 54, wherein a mounting of the entrainment unit 54 in the delay slit 20 shifts further in the seat direction 52. Here, the backrest unit 12 moves in translation in the seat direction 52. The delay element 22 comprising the delay slit 20 deforms by means of an acceleration of the attachment point 16. The acceleration of the attachment point 16 occurs due to an increased force acting on the backrest unit 12. The increased force acting on the backrest unit 12 occurs due to an acceleration of the element, more specifically of the backrest unit 12, caused by the crash situation. The acceleration of the element caused by the crash situation causes the movement of the element.

Due to the tapering course of the delay slit 20, a selective, defined introduction of the force can be achieved. A magnitude of an energy that can be taken up by the seat energy absorption unit 14 by plastic deformation can be adjusted by a design of the seat energy absorption unit 14. The seat energy absorption unit 14 can thus be adapted to a large number of requirements.

Alternatively, further embodiments of the seat energy absorption unit are conceivable. For example, it is conceivable for the seat energy absorption unit to be formed in a number of parts. For example, the seat energy absorption unit is formed in two parts. Here, the seat energy absorption unit has a seat energy absorption unit bearing element that is attached to a backrest unit and that comprises a delay element delimiting a delay slit. In addition, the seat energy absorption unit has a further seat energy absorption unit bearing element that surrounds the first-mentioned seat energy absorption unit bearing element and comprises an entrainment unit, which is mounted in the delay slit arranged on the first-mentioned seat energy absorption unit bearing element. In this example, the seat energy absorption unit is intended to decelerate the movement of the element by a cooperation of the two seat energy absorption unit bearing elements. Further embodiments of the delay slit are likewise conceivable. For example, the delay slit has merely a tapering course (with avoidance of the widening course). Here, an embodiment of the delay slit as a substantially acute triangle starting from an attachment point is likewise conceivable. Furthermore, it is conceivable for the delay slit, starting from an end of an attachment point pointing toward the delay slit, to have a substantially constant slit transverse extension, wherein the slit transverse extension is smaller than a slit transverse extension of the attachment point. Here, it is conceivable for the substantially constant slit transverse extension to have a substantially circular end at an end pointing away from the attachment point.

List of reference signs

| | |
|---|---|
| 10 | seat energy absorption |
| | device |
| 12 | backrest unit |
| 14 | seat energy absorption |
| | unit |
| 16 | attachment point |
| 18 | transverse |
| | reinforcement unit |
| 20 | delay slit |
| 22 | delay element |
| 24 | slit transverse |
| | extension |
| 26 | slit transverse |
| | extension |
| 28 | longitudinal direction |
| 30 | seat |
| 32 | lower region |
| 34 | stand unit |
| 36 | supporting tube |
| 38 | seat divider |
| 40 | backrest frame |
| 42 | backrest bearing point |
| 44 | transverse |
| | reinforcement unit |
| | transverse direction |
| 46 | bearing unit |
| 48 | further bearing unit |
| 50 | hydrolock |
| 52 | seat direction |
| 54 | entrainment unit |
| 56 | bearing element |
| 58 | bearing unit |
| | receptacle |
| 60 | slit longitudinal |
| | extension |
| 62 | entrainment element |
| 64 | entrainment head |
| 66 | side element |
| 68 | connecting element |
| 70 | plane of symmetry |
| 72 | shaped recess |
| 74 | vertical direction |
| 76 | further attachment |
| | point |
| 78 | further entrainment |
| | unit |

1. A seat energy absorption device, in particular an aircraft seat energy absorption device, which is intended, to at least partly absorb at least one primary acceleration movement of at least one backrest unit, at least in a crash situation, comprising at least one seat energy absorption unit, which is intended to be moved, in a crash situation, in at least one direction deviating from the primary acceleration movement of the backrest unit.

2. The seat energy absorption device according to claim 1, wherein the seat energy absorption unit has at least one attachment point, which is intended at least for an attachment of the seat energy absorption unit to at least one transverse reinforcement unit.

3. The seat energy absorption device according to claim 2, wherein the transverse reinforcement unit is formed as a torsion element.

4. The seat energy absorption device according to claim 1, wherein the seat energy absorption unit has at least one delay element which delimits at least one delay slit and which is intended to decelerate a movement of at least one element, in the crash situation.

5. The seat energy absorption device at least according to claim 4, wherein the delay slit has at least two different slit transverse extensions.

6. The seat energy absorption device according to claim 1, wherein the seat energy absorption unit is intended to absorb energy at least by plastic deformation, in the crash situation.

7. The seat energy absorption device according to claim 1, wherein the seat energy absorption unit has at least one at least substantially U-shaped form in at least one cross-sectional plane.

8. The seat energy absorption device according to claim 1, wherein the seat energy absorption unit has an at least substantially arc-like form in a longitudinal direction.

9. The seat energy absorption device, in particular an aircraft seat, comprising at least one seat energy absorption device according to claim 1.

10. The seat energy absorption device according to claim 9, comprising at least one backrest unit, which is intended to be linked to the seat energy absorption device in a lower region of the backrest unit.

11. The seat energy absorption device according to claim 2, wherein the seat energy absorption unit has at least one delay element which delimits at least one delay slit and which is intended to decelerate a movement of at least one element, in the crash situation.

12. The seat energy absorption device according to claim 2, wherein the seat energy absorption unit is intended to absorb energy at least by plastic deformation, in the crash situation.

13. The seat energy absorption device according to claim 2, wherein the seat energy absorption unit has at least one at least substantially U-shaped form in at least one cross-sectional plane.

14. The seat energy absorption device according to claim 2, wherein the seat energy absorption unit has an at least substantially arc-like form in a longitudinal direction.

15. The seat energy absorption device, in particular an aircraft seat, comprising at least one seat energy absorption device according to claim 2.

16. The seat energy absorption device according to claim 3, wherein the seat energy absorption unit has at least one delay element which delimits at least one delay slit and which is intended to decelerate a movement of at least one element, in the crash situation.

17. The seat energy absorption device according to claim 3, wherein the seat energy absorption unit is intended to absorb energy at least by plastic deformation, in the crash situation.

18. The seat energy absorption device according to claim 3, wherein the seat energy absorption unit has at least one at least substantially U-shaped form in at least one cross-sectional plane.

19. The seat energy absorption device according to claim 3, wherein the seat energy absorption unit has an at least substantially arc-like form in a longitudinal direction.

20. The seat energy absorption device, in particular an aircraft seat, comprising at least one seat energy absorption device according to claim 3.
